(19) United States
(12) Patent Application Publication
(10) Pub. No.: US 2015/0286417 A1
(43) Pub. Date: Oct. 8, 2015

(54) MEMORY SYSTEM AND SEMICONDUCTOR SYSTEM

(71) Applicant: SK hynix Inc., Gyeonggi-do (KR)

(72) Inventor: Min-Seok CHOI, Gyeonggi-do (KR)

(21) Appl. No.: 14/489,190

(22) Filed: Sep. 17, 2014

(30) Foreign Application Priority Data
Apr. 4, 2014 (KR) 10-2014-0040605

(51) Int. Cl. G06F 3/06; G06F 1/10

(52) U.S. Cl. CPC G06F 3/0611; G06F 3/0604; G06F 3/0659; G06F 3/0673; G06F 1/10

(57) ABSTRACT

A memory system includes a memory controller suitable for generating process skew information thereof, and a semiconductor memory device suitable for controlling an operation of an internal circuit based on the process skew information.

### CROSS-REFERENCE TO RELATED APPLICATIONS

The present application claims priority of Korean Patent Application No. 10-2014-0040605, filed on Apr. 4, 2014, which is incorporated herein by reference in its entirety.

### BACKGROUND

1. Field

Exemplary embodiments of the present invention relate to a semiconductor design technology and, more particularly, to a memory system having an interface structure between a semiconductor memory device and a memory controller.

2. Description of the Related Art

In a memory system in which a memory controller and a semiconductor memory device communicate with each other, the memory controller generally transmits main signals, such as addresses, commands and data, to the semiconductor memory device in order to write or read data. In an ideal world there is no process skew between the memory controller and the semiconductor memory device, transistor performance in each chip is the same, and each chip has the characteristics specified in their design. To further explain, the design characteristics may include input/output signal margin, internal signal margin, operating speed and power consumption.

Ideally, the input buffer or the internal circuit of the semiconductor memory device process signal's, which are transmitted from the memory controller, without delaying or advancing the signals. Accordingly, the operations to read out information from a memory cell or to write information to a memory cell should be performed at the designed speed. However, under real world fabrication conditions, process skew occurs between the memory controller and the semiconductor memory devices. Therefore, a method is needed to deal with the process skew.

### SUMMARY

Various exemplary embodiments of the present invention are directed to a memory system capable of controlling an operation of an internal circuit based on process skew.

In accordance with an exemplary embodiment of the present invention, a memory system may include a memory controller suitable for generating process skew information thereof, and a semiconductor memory device suitable for controlling an operation of an internal circuit based on the process skew information.

In accordance with another exemplary embodiment of the present invention, a memory system may include a semiconductor memory device suitable for controlling the operating speed of an internal circuit in response to first process skew information in a first mode, and generating and outputting second process skew information corresponding to the operating speed of the internal circuit in a second mode, and a memory controller suitable for generating the first process skew information corresponding to an operating speed thereof and outputting the first process skew to the semiconductor memory device in the first mode, and controlling the operating speed thereof in response to the second process skew information in the second mode.

In accordance with still another exemplary embodiment of the present invention, a semiconductor system may include a first device suitable for generating and outputting process skew information thereof, and a second device suitable for setting an operation environment of an internal circuit in response to the process skew information and communicating with the first device in a set operation environment.

### BRIEF DESCRIPTION OF THE DRAWINGS

FIG. 1 is a block diagram illustrating a memory system in accordance with an exemplary embodiment of the present invention.

FIG. 2 is a detailed block diagram illustrating a semiconductor memory device shown in FIG. 1.

FIG. 3 is a detailed block diagram illustrating skew control unit of the semiconductor memory device shown in FIG. 2.

FIG. 4 is a detailed block diagram illustrating a skew detection unit of the semiconductor memory device shown in FIG. 2.

FIG. 5 is a block diagram illustrating a memory system in accordance with another exemplary embodiment of the present invention.

### DETAILED DESCRIPTION

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. The drawings are not necessarily to scale and in some instances, proportions may have been exaggerated in order to clearly illustrate features of the embodiments. Throughout the disclosure, reference numerals correspond directly to the like numbered parts in the various figures and embodiments of the present invention. It is also noted that in this specification, “connected/coupled” refers to one component not only directly coupling another component but also indirectly coupling another component through an intermediate component. In addition, a singular form may include a plural form, and vice versa, as long as it is not specifically mentioned.

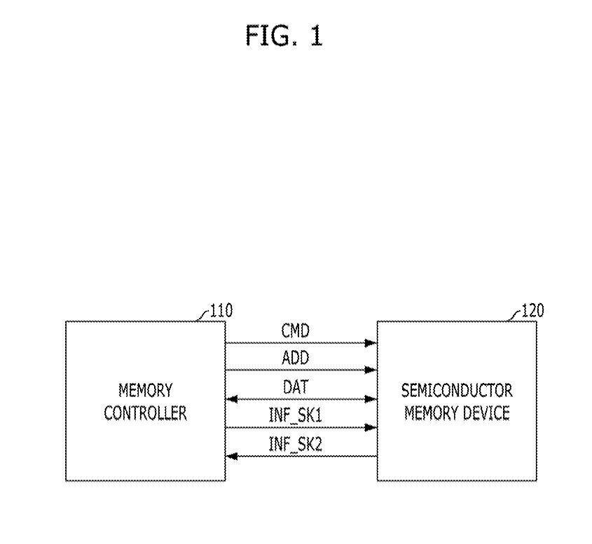

FIG. 1 is a block diagram illustrating a memory system in accordance with an exemplary embodiment of the present invention.

Referring to FIG. 1, the memory system may include a memory controller 110 and a semiconductor memory device 120.

The memory controller 110 generates first process skew information INF_SK1 corresponding to its operating speed, transmits the first process skew information INF_SK1 to the semiconductor memory device 120, and receives second process skew information INF_SK2 of the semiconductor memory device 120 from the semiconductor memory device 120. Although the exemplary embodiment of the present invention has cited as an example that the first and second process skew information INF_SK1 and INF_SK2 are transmitted through separate transmission lines, the first and second process skew information INF_SK1 and INF_SK2 may be transmitted through existing transmission lines. That is, the memory controller 110 may transmit the first process skew information INF_SK1 contained in a command CMD, an address ADD or data DAT to the semiconductor memory device 120, and may receive the second process skew information INF_SK2 contained in the data DAT from the semiconductor memory device 120.

Hereinafter, for a simplified description, the section where the first process skew information INF_SK1 is transmitted is defined as a first mode, and the section where the second process skew information INF_SK2 is transmitted is defined as a second mode.

The semiconductor memory device 120 controls an operation of an internal circuit in response to the first process skew information INF_SK1 in the first mode. Further, the semiconductor memory device 120 generates and outputs the second process skew information INF_SK2 corresponding to its operating speed, and the memory controller 110 controls an operation of an internal circuit in response to the second process skew information INF_SK2 in the second mode.

An operation of the memory system will now be explained.

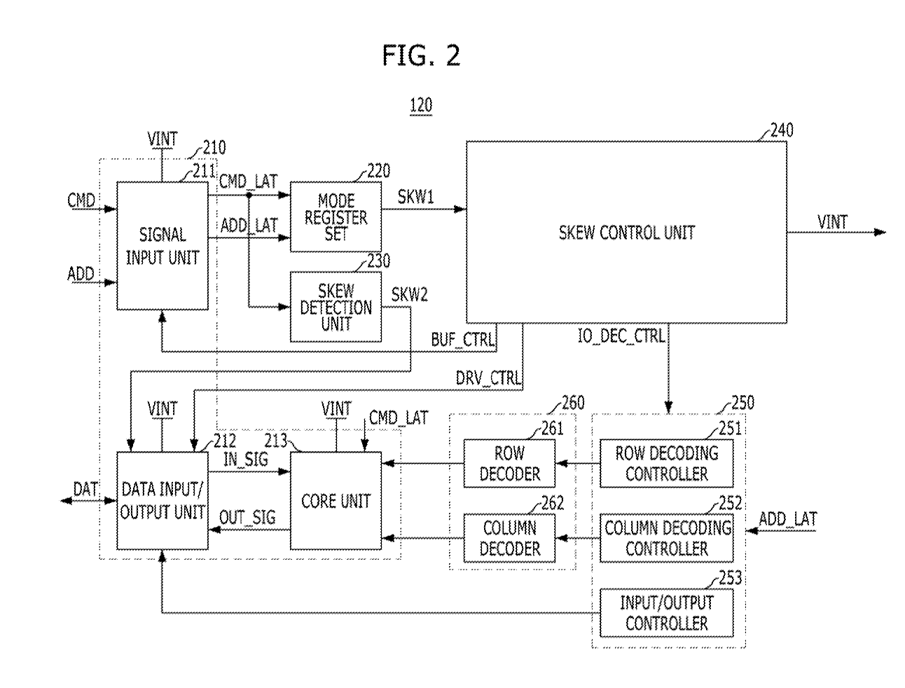

In the first mode, the memory controller 110 generates and outputs the first process skew information INF_SK1 corresponding to its operating speed, and the semiconductor memory device 120 receives the first process skew information INF_SK1 to control the operation of the internal circuit. For example, the semiconductor memory device 120 may adjust a voltage level of an internal voltage used in the internal circuit or operating speed of the internal circuit in response to the first process skew information INF_SK1. A detailed description thereof will be explained with reference to FIG. 2.

In the second mode, the semiconductor memory device 120 generates and outputs the second process skew information INF_SK2 corresponding to its operating speed, and the memory controller 110 receives the second process skew information INF_SK2 to control the operation of the internal circuit. For example, the semiconductor memory device 120 and the memory controller 110 may similarly adjust internal voltage levels used in the internal circuit or the operating speed of the internal circuit in response to the second process skew information INF_SK2.

The memory system in accordance with the exemplary embodiment of the present invention may control the operating speed of the internal circuits in the memory controller 110 or the semiconductor memory device 120 by using the first process skew information INF_SK1 or the second process skew information INF_Sk2 depending on the first mode and the second mode.

FIG. 2 is a detailed block diagram illustrating the semiconductor memory device 120 shown in FIG. 1.

Referring to FIG. 2, the semiconductor memory device 120 may include an internal circuit 210, a mode register set 220, a skew detection unit 230, a skew control unit 240, an input/output and decoding control unit 250 and a decoding unit 260.

In FIG. 2, the semiconductor memory device 120 sets the first mode and the second mode in response to the command CMD, receives the first process skew information INF_SK1 through the address ADD, and outputs the second process skew information INF_SK2 through the data DAT.

The internal circuit 210 may include a signal input unit 211, a data input/output unit 212 and a core unit 213 to perform a write operation and a read operation of the data DAT.

The signal input unit 211 receives the command CMD and the address ADD, and performs a buffering operation and a latching operation on the command CMD and the address ADD to output a latched command CMD_LAT and a latched address ADD_LAT. In response to the latched command CMD_LAT, the semiconductor memory device 120 may perform an operation in the first mode or the second mode. The mode register set 220 operates in the first mode while the skew detection unit 230 operates in the second mode.

The data input/output unit 212 receives and outputs the data DAT. The data input/output unit 212 receives the data DAT to provide an input data signal IN_SIG to the core unit 213 during the write operation, and receives an output data signal OUT_SIG from the core unit 213 to provide the data DAT to the memory controller 110 of FIG. 1 during the read operation.

The core unit 213 includes a plurality of memory cells, and accesses a memory cell designated by the latched address ADD_LAT in response to the latched command CMD_LAT. The core unit 213 writes the input data signal IN_SIG provided from the data input/output unit 212 in the designated memory cell during the write operation, and reads out the output data signal OUT_SIG from the designated memory cell to provide the output data signal OUT_SIG to the data input/output unit 212 during the read operation.

Although the exemplary embodiment of the present invention shows the internal circuit 210 including the signal input unit 211, the data input/output unit 212 and the core unit 213, the semiconductor memory device 120 may further include various internal circuits in addition to the signal input unit 211, the data input/output unit 212 and the core unit 213.

The mode register set 220 stores first process skew information SKW1 inputted from the Patched address ADD_LAT in response to the latched command CMD_LAT. Here, the first process skew information SKW1 includes the first process skew information INF_SK1 corresponding to the operating speed of the memory controller 110 of FIG. 1.

Although the exemplary embodiment of the present invention shows the mode register set 220 as an example of where to store the skew information, the semiconductor memory device 120 may use other types of registers.

The skew detection unit 230 generates second process skew information SKW2 corresponding to the operating speed of the semiconductor memory device 120 in response to the latched command CMD_LAT. The generated second process skew information SKW2 is inputted to the data input/output unit 212, included in the data DAT, and transmitted to the memory controller 110 of FIG. 1. Here, the skew detection unit 230 may be implemented with a combination of an oscillator or various logic circuits. A detailed description thereof will be explained with reference to FIG. 4.

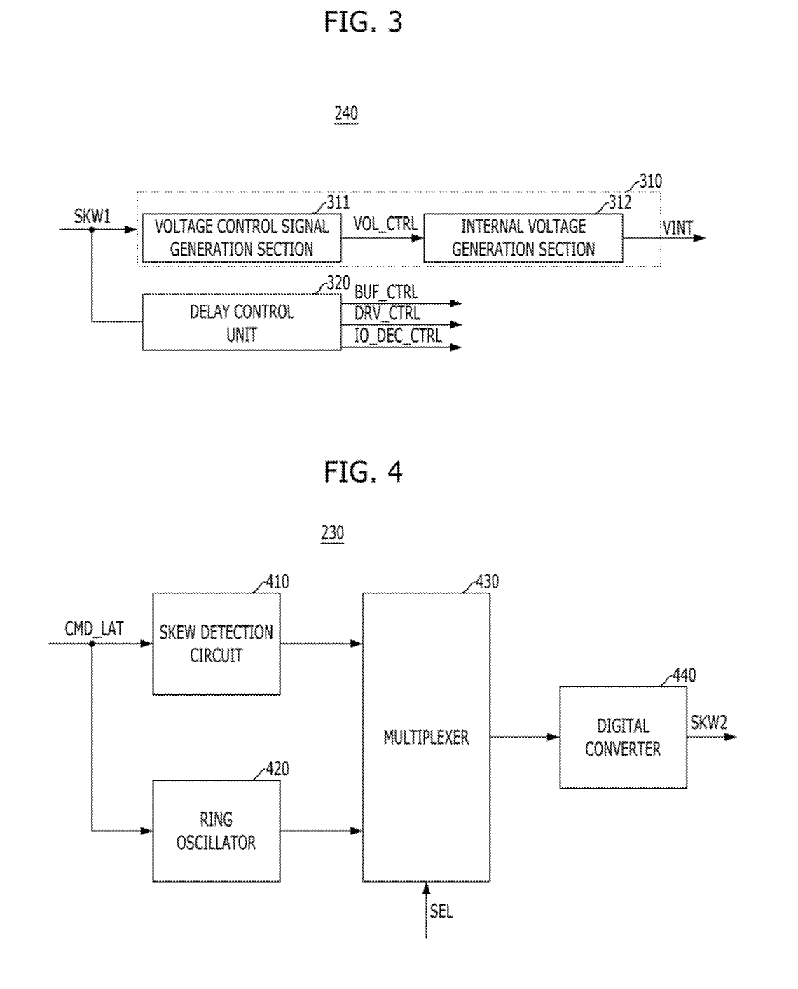

The skew control unit 240 controls the operating speed of the internal circuit 210 in response to the first process skew information SKW1. In order to control the operating speed of the internal circuit 210, the skew control unit 240 adjusts the voltage level of an internal voltage VINT to be supplied to the internal circuit 210 in response to the first process skew information SKW1. The internal voltage VINT with an adjusted voltage level is supplied to the internal circuit 210. Furthermore, the skew control unit 240 generates a plurality of control signals BUF_CTRL, DRV_CTRL and IO_DEC_CTRL for controlling a setup/hold time of the signal input unit 211 or a delay time of the data input/output unit 212 and the core unit 213 in response to the first process skew information SKW1. Accordingly, the skew control unit 240 may control the voltage level of the internal voltage VINT, or the operating speed of the internal circuit 210 by generating the control signals BUF_CTRL, DRV_CTRL and IO_DEC_CTRL, in response to the first process skew information SKW1. A detailed description thereof will be explained with reference to FIG. 3.

The input/output and decoding control unit 250 may include a row decoding controller 251, a column decoding controller 252 and an input/output controller 253.

The row decoding controller 251, the column decoding controller 252 and the input/output controller 253 may control operating speeds of a row decoder 261, a column decoder 262 and the data input/output unit 212, respectively, by adjusting the delay time thereof based on an input/output and decoding control signal IO_DEC_CTRL in response to the latched address ADD_LAT.

The decoding unit 260 may include a row decoder 261 and a column decoder 262. The row decoder 261 selects a bit line of a memory cell to be accessed within the core unit 213 based on the delay time which is adjusted by the row decoding controller 251. The column decoder 262 selects a word line of a memory cell to be accessed within the core unit 213 based on the delay time which is adjusted by the row column decoding controller 252.

Accordingly, the core unit 213 may access a memory cell designated by the latched address ADD_LAT in response to the first process skew information SKW1 corresponding to the operating speed of the memory controller 110 of FIG. 1.

In the memory system in accordance with the exemplary embodiment of the present invention, the memory controller 110 and the semiconductor memory device 120 each control the operation of the internal circuits in response to the other's process skew information. Accordingly, the memory system may control the data communication characteristics between the memory controller 110 and the semiconductor memory device 120, and may prevent errors.

FIG. 3 is a detailed block diagram illustrating the skew control unit 240 of the semiconductor memory device 120 shown in FIG. 2.

Referring to FIGS. 2 and 3, the skew control unit 240 may include a voltage control unit 310 and a delay control unit 320.

The voltage control unit 310 may include a voltage control signal generation section 311 and an internal voltage generation section 312. The voltage control signal generation section 311 outputs a voltage control signal VOL_CTRL for controlling the voltage level of the internal voltage VINT in response to the first process skew information SKW1. The internal voltage generation section 312 generates the internal voltage VINT by adjusting the voltage level of the internal voltage VINT in response to the voltage control signal VOL_CTRL. For example, where the first process skew information SKW1 denotes that the memory controller 110 of FIG. 1 has a fast paced process environment, the operating environment of the semiconductor memory device 120 may be controlled to correspond to the fast paced process environment by increasing the voltage level of the internal voltage VINT used in the semiconductor memory device 120. In reverse, where the first process skew information SKW1 denotes that the memory controller 110 of FIG. 1 has a slow paced process environment, the operating environment of the semiconductor memory device 120 may be controlled to correspond to the slow paced process environment by decreasing the voltage level of the internal voltage VINT used in the semiconductor memory device 120. The internal voltage VINT generated by the voltage control unit 310 is supplied as a supply voltage to the internal circuit 210 including the signal input unit 211, the data input/output unit 212 and the core unit 213 of FIG. 2. Accordingly, it may control the operating speed thereof.

The delay control unit 320 outputs a buffer control signal BUF_CTRL for controlling the setup/hold time of the signal input unit 211, a driving control signal DRV_CTRL for controlling the delay time of the data input/output unit 212, and the input/output and decoding control signal IO_DEC_CTRL for controlling the delay time of the core unit 213 in response to the first process skew information SKW1.

Here, the buffer control signal BUF_CTRL controls a setup/hold time of a buffer circuit which performs a buffering operation in the signal′ input unit 211. At this time, the setup/hold time may be controlled by changing the size of capacitors or resistors used in the buffer circuit in response to the first process skew information SKW1 contained in the buffer control signal BUF_CTRL. In conclusion, the operating speed of the signal input unit 211 may be controlled by adjusting the setup/hold time of the signal input unit 211 in response to the first process skew information SKW1.

The driving control signal DRV_CTRL controls the delay time of an input/output driver which receives and outputs the data DAT in the data input/output unit 212. In other words, the delay amount of a delay circuit for adjusting the delay time of the input/output driver is controlled to correspond to the first process skew information SKW1. For example, the delay time (or the delay amount) may be controlled by changing the size of capacitors or resistors used in the delay circuit. The input/output timing of the data DAT may be controlled to correspond to the operating speed of the memory controller 110 by decreasing the size of the capacitors or resistors used in the delay circuit when the memory controller 110 of FIG. 1 has a fast paced environment, or by increasing the size of the capacitors or resistors used in the delay circuit when the memory controller 110 of FIG. 1 has a slow paced environment. In conclusion, the operating speed of the data input/output unit 212 may be controlled by adjusting the delay time of the input/output driver thereof in response to the first process skew information SKW1.

The input/output and decoding control signal IO_DEC_CTRL controls the delay time of the row decoding controller 251, the column decoding controller 252 and the input/output controller 253. Like the driving control signal DRV_CTRL, the delay time may be controlled to correspond to the operating speed of the memory controller 110 by changing the size of capacitors or resistors used in each delay circuit of the row decoding controller 251, the column decoding controller 252 and the input/output controller 253. In conclusion, the input/output and decoding control unit 250 may control the operating speed of the row decoder 261, the column decoder 262 and the data input/output unit 212 by adjusting the delay time thereof based on the first process skew information SKW1 in response to the latched address ADD_LAT.

The skew control unit 240 in accordance with the exemplary embodiment of the present invention may control the voltage level of the internal voltage VINT, or the operating speed of the internal circuit 210, by generating the control signals BUF_CTRL, DRV_CTRL and IO_DEC_CTRL, in response to the first process skew information SKW1.

FIG. 4 is a detailed block diagram illustrating the skew detection unit 230 of the semiconductor memory device 120 shown in FIG. 2.

Referring to FIGS. 2 and 4, the skew detection unit 230 may include a skew detection circuit 410, a ring oscillator 420, a multiplexer 430 and a digital converter 440.

The skew detection circuit 410 detects skew information of the semiconductor memory device 120 in response to the latched command CMD_LAT. Although not shown in FIG. 4, the skew detection circuit 410 may be implemented with a combination of various logic circuits. For example, plural logic circuits used in the semiconductor memory device 120 may be coupled in series in the skew detection circuit 410. The plural logic circuits may include a sense amplifier, a driver composed of inverters, an RC delay, a word line driver, a flip-flop, a level shifter and the like. By using a circuit through which an internal signal actually passes, the skew information of the semiconductor memory device 120 may be accurately detected.

The ring oscillator 420 detects skew information of the semiconductor memory device 120 in response to the latched command CMD_LAT. The ring oscillator 420 may be implemented with a plurality of inverters to detect the skew information by measuring a delay time thereof.

The multiplexer 430 outputs the skew information which is detected by the skew detection circuit 410 or the ring oscillator 420 in response to a selection signal SEL. Since the ring oscillator 420 is composed of only the inverters, the ring oscillator 420 may not accurately reflect the skew information of the semiconductor memory device 120. Therefore, the multiplexer 430 may select and output the skew information that is accurately detected by the skew detection circuit 410 in response to the selection signal SEL.

The digital converter 440 converts the skew information, which is detected by the skew detection circuit 410 or the ring oscillator 420 and outputted from the multiplexer 430, into a digital code, and outputs the digital code as the second process skew information SKW2. Since the skew information detected by the skew detection circuit 410 or the ring oscillator 420 is outputted as a continuous pulse, the skew information of the continuous pulse has to be converted into the digital code. The second process skew information SKW2 outputted from the digital converter 440 is inputted to the data Input/output unit 212, included in the data DAT, and transferred to the memory controller 110 of FIG. 1.

The skew detection unit 230 in accordance with the exemplary embodiment of the present invention may detect the second process skew information SKW2 corresponding to the operating speed of the semiconductor memory device 120, and transmit the detected second process skew information SKW2 to the memory controller 110 through the data DAT.

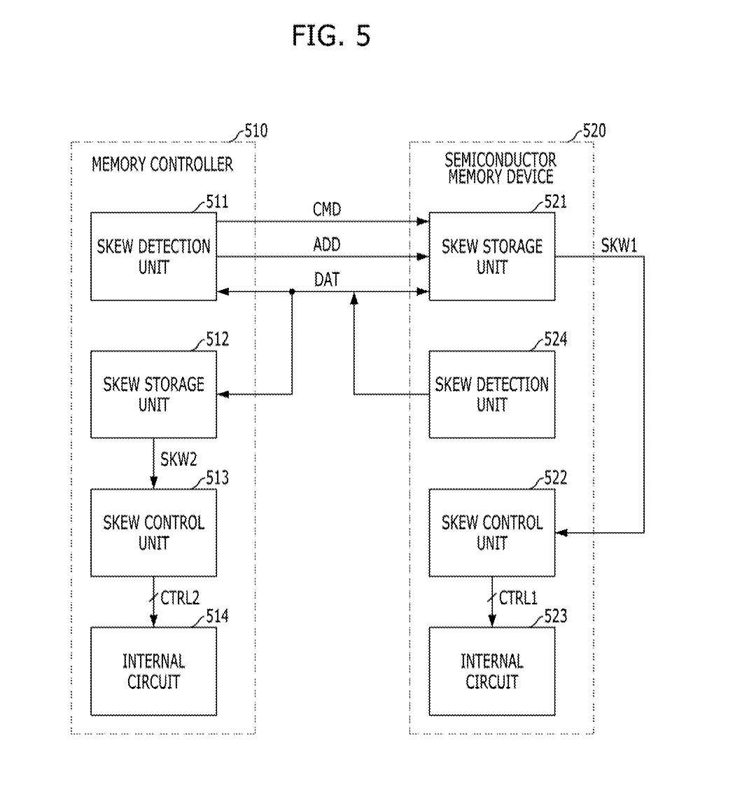

FIG. 5 is a block diagram illustrating a memory system in accordance with another exemplary embodiment of the present invention.

Referring to FIG. 5, the memory system includes a memory controller 510 and a semiconductor memory device 520. Each of the memory controller 510 and the semiconductor memory device 520 may include a skew detection unit 511 and 524, a skew storage unit 512 and 521, a skew control unit 513 and 522, and an internal circuit 514 and 523.

The skew detection units 511 and 524 detect and transmit first process skew information SKW1 and second process skew information SKW2, which correspond to the operating speed of the memory controller 510 and the operating speed of the semiconductor memory device 520, respectively. The skew detection unit 511 of the memory controller 510 may transmit the first process skew information SKW1 included into a command CMD, an address ADD or data DAT. The skew detection unit 524 of the semiconductor memory device 520 may transmit the second process skew information SKW2 included into the data DAT.

The skew storage units 512 and 521 store the second process skew information SKW2 and the first process skew information SKW1 transmitted from the semiconductor memory device 520 and the memory controller 510, respectively.

The skew control units 513 and 522 generate a plurality of control signals CTRL1 and CTRL2 for controlling the operating speed of the internal circuits 514 and 523 in response to the corresponding first process skew information SKW1 and second process skew information SKW2. The plurality of control signals, CTRL1 and CTRL2 for example, may include the internal voltage VINT, the buffer control signal BUF_CTRL, the driving control signal DRV_CTRL, and the input/output and decoding control signal IO_DEC_CTRL shown in FIG. 2. Accordingly, the internal circuits 514 and 523 may control their operating speeds in response to the plurality of control signals CTRL1 and CTRL2.

The memory system in accordance with the exemplary embodiment of the present invention may control the operating speed of the internal circuits 514 and 523 by using the first process skew information SKW1 and the second process skew information SKW2. Accordingly, the memory system may control the data communication circumstances and timing between the memory controller 510 and the semiconductor memory device 520 and may prevent communication errors.

Although it has been described that the memory system controls the operating speed of the internal circuits 514 and 523 by exchanging process skew information between the memory controller 510 and the semiconductor memory device 520, the present invention is not limited to this structure. For example, in addition to process skew information, internal operating status information, internal temperature information and the like may be exchanged between the memory controller 510 and the semiconductor memory device 520.

According to the exemplary embodiments of the present invention as described above, the memory system may optimize the data communication between the memory controller and the semiconductor memory devices by controlling the operation of the internal circuits in response to process skew information.

While the present invention has been described with respect to specific embodiments, it will be apparent to those skilled in the art that various changes and modifications may be made without departing from the spirit and scope of the invention as defined in the following claims.

What is claimed is:

1. A memory system comprising:
a memory controller suitable for generating process skew information thereof; and
a semiconductor memory device suitable for controlling an operation of an internal circuit based on the process skew information.

2. The memory system of claim herein the internal circuit comprises:
a signal input unit suitable for receiving a command and an address;
a data input/output unit suitable for receiving and outputting data; and
a core unit including memory cells that is suitable for accessing a memory cell designated by the address, among the memory cells, in response to the command.

3. The memory system of claim 2, wherein the semiconductor memory device comprises:
a skew storage unit suitable for storing the process skew information.

4. The memory system of claim 3, wherein the skew storage unit includes a mode register set or a register unit.

5. The memory system of claim 2, wherein the semiconductor memory device comprises:
a skew control unit suitable for controlling an operating speed of the internal circuit based on the process skew information.

6. The memory system of claim 5, wherein the skew control unit comprises:
a delay control unit suitable for controlling a setup, hold time of the signal input unit and a delay time of the data input/output unit and the core unit based on the process skew information; and
a voltage control unit suitable for controlling an internal voltage used in the internal circuit based on the process skew information.

7. The memory system of claim 6, wherein the voltage control unit comprises:
a voltage control signal generation section suitable for generating a voltage control signal for controlling the internal voltage based on the process skew information; and
an internal voltage generation section suitable for generating the internal voltage in response to the voltage control signal.

8. A memory system comprising:
a semiconductor memory device suitable for controlling an operating speed of an internal circuit in response to first process skew information in a first mode, and generating and outputting second process skew information corresponding to the operating speed of the internal circuit in a second mode; and
a memory controller suitable for generating the first process skew information corresponding to an operating speed thereof and outputting the first process skew information to the semiconductor memory device in the first mode, and controlling the operating speed thereof in response to the second process skew information in the second mode.

9. The memory system of claim 8, wherein the internal circuit comprises:
a signal input unit suitable for receiving the command and the address;
a data input/output unit suitable or receiving and outputting the data; and
a core unit including memory cells and suitable for accessing a memory cell designated by the address, among the memory cells, in response to the command.

10. The memory system of claim wherein the semiconductor memory device comprises:
a skew storage unit suitable for storing the first process skew information.

11. The memory system of claim 10, wherein the skew storage unit includes a mode register set or a register unit.

12. The memory system of claim 9, wherein the semiconductor memory device comprises:
a skew control unit suitable for controlling the operating speed of the internal circuit in response to the first process skew information in the first mode; and
a skew detection unit suitable for detecting the second process skew information in the second mode.

13. The memory system of claim 12, wherein the skew control unit comprises:
a delay control unit suitable for controlling a setup/hold time of the signal input unit and controlling a delay time of the data input/output unit and the core unit in response to the first process skew information; and
a voltage control unit suitable for controlling an internal voltage used in the internal circuit in response to the first process skew information.

14. The memory system of claim 13, wherein the voltage control unit comprises:
a voltage control signal generation section suitable for generating a voltage control signal for controlling the internal voltage in response to the first process skew information; and
an internal voltage generation section suitable for generating the internal voltage in response to the voltage control signal.

15. The memory system of claim 12, wherein the skew detection unit comprises:
a skew detection circuit suitable for detecting the second process skew information in response to the command;
a ring oscillator suitable for detecting the second process skew information in response to the command;
a multiplexer suitable for selectively outputting the second process skew information detected by the skew detection circuit or the ring oscillator in response to a selection signal; and
a digital converter suitable for converting the second process skew information selected by the multiplexer into a digital code.

16. The memory system of claim 8, wherein the memory controller comprises:
a skew storage unit suitable for storing the second process skew information in the second mode; and
a skew control unit suitable for controlling an operating speed of an internal circuit in response to the second process skew information stored in the skew storage unit.

17. The memory system of claim 8, wherein the first and second modes are set in response to the command.

18. The memory system of claim 8, wherein the memory controller and the semiconductor memory device transmit the first process skew information and the second process skew information through a common line.

19. A semiconductor system comprising:
a first device suitable for generating and outputting process skew information thereof; and
a second device suitable for setting an operation environment of an internal circuit in response to the process skew information and communicating with the first device in a set operation environment.

20. The semiconductor system of claim 19, wherein the second device comprises:
a skew storage unit suitable for storing the process skew information; and
a skew control unit suitable for controlling an operating speed of the internal circuit or an internal voltage used in the internal circuit in response to the process skew information.
